(19) United States
(12) Patent Application Publication
(10) Pub. No.: US 2017/0103280 A1
(43) Pub. Date: Apr. 13, 2017

(54) PROCESSING APPARATUS, PROCESSING SYSTEM, IMAGE PICKUP APPARATUS, PROCESSING METHOD, AND NON-TRANSITORY COMPUTER-READABLE STORAGE MEDIUM

(71) Applicant: CANON KABUSHIKI KAISHA, Tokyo (JP)

(72) Inventors: Yuichi Kusumi, Utsunomiya-shi (JP); Chiaki Inoue, Utsunomiya-shi (JP); Yoshiaki Ida, Utsunomiya-shi (JP)

(21) Appl. No.: 15/276,839

(22) Filed: Sep. 27, 2016

(30) Foreign Application Priority Data
Oct. 8, 2015 (JP) 2015-200032

(51) Int. Cl. G06K 9/46; G06T 7/00

(52) U.S. Cl. CPC G06K 9/4661; G06T 7/0081

(57) ABSTRACT

A processing apparatus includes a luminance information obtainer that obtains luminance information for each of a plurality of images, each of which is shot respectively when the light source arranged at mutually different positions illuminates an object, and a normal information determiner that determines normal information of the object from a plurality of normal candidates calculated using three or more polarization images with polarization states different in each other on the basis of the luminance information.

### BACKGROUND OF THE INVENTION

Field of the Invention

The present invention relates to a processing apparatus, a processing system, an image pickup apparatus, a processing method, and a non-transitory computer-readable storage medium.

Description of the Related Art

Obtaining more physical information regarding an object can generate images based on a physical model in image processing after imaging. For example, an image where visibility of the object is changed can be generated. Visibility of an object is determined based on information such as shape information of the object, reflectance information of the object and light source information. As physical behavior of reflected light that is emitted from a light source and is reflected by the object depends on a local surface normal, using not three-dimensional information but the surface normal of the object as shape information is especially effective.

As a method obtaining the surface normal, a method estimating a surface normal from polarization information (degree of polarization and a polarization azimuth) of light reflected by the object has been known. However, due to indefiniteness of a solution, uniquely determining the surface normal from surface normals estimated from the polarization information is difficult. International Publication WO2009/147814 discloses a method uniquely determining the surface normal using polarization information different in viewpoint positions. Japanese Patent Laid-Open No. 2010-279044 also discloses a method uniquely calculating the surface normal under conditions where information regarding an object shape has been already known.

However, in the method disclosed in International Publication WO2009/147814, extracting a corresponding point of a pixel corresponding to each position of the object in each parallax image is required, but a method extracting the corresponding point matters. Moreover, in the method disclosed in Japanese Patent Laid-Open No. 2010-279044, when the object shape is preliminarily unknown, determining the surface normal is difficult.

### SUMMARY OF THE INVENTION

In the view of the problem, the present invention can provides a processing apparatus, a processing system, an image pickup apparatus, a processing method, and a non-transitory computer-readable storage medium capable of resolving indefiniteness of a solution of normal information calculated from polarization information at a single viewpoint under a condition where information regarding an object shape is preliminarily unknown.

A processing apparatus according to one aspect of the present invention includes a luminance information obtainer that obtains luminance information for each of a plurality of images, each of the images being shot respectively when the light source arranged at mutually different positions illuminates an object, and a normal information determiner that determines normal information of the object from a plurality of normal candidates calculated using three or more polarization images with polarization states different in each other on the basis of the luminance information.

A processing system according to another aspect of the present invention includes at least one light source that illuminates an object, and a processing apparatus. The processing apparatus includes a luminance information obtainer that obtains luminance information for each of a plurality of images, each of the images being shot respectively when the light source arranged at mutually different positions illuminates the object, and a normal information determiner that determines normal information of the object from a plurality of normal candidates calculated using three or more polarization images with polarization states different in each other on the basis of the luminance information.

An image pickup apparatus according to another aspect of the present invention includes a processing apparatus, and an image pickup element that images an object. The processing apparatus includes a luminance information obtainer that obtains luminance information for each of a plurality of images, each of the images being shot respectively when the light source arranged at mutually different positions illuminates the object, and a normal information determiner that determines normal information of the object from a plurality of normal candidates calculated using three or more polarization images with polarization states different in each other on the basis of the luminance information.

A processing method according to another aspect of the present invention includes a step of obtaining luminance information for each of a plurality of images, each of the images being shot respectively when the light source arranged at mutually different positions illuminates the object, and a step of determining normal information of the object from a plurality of normal candidates calculated using three or more polarization images with polarization states different in each other on the basis of the luminance information.

Further features of the present invention will become apparent from the following description of exemplary embodiments with reference to the attached drawings.

### BRIEF DESCRIPTION OF THE DRAWINGS

FIG. 1 is an appearance view of an image pickup apparatus according to a first example.

FIG. 2A is a block diagram of the image pickup apparatus according to the first example.

FIG. 2B is a block diagram of a processing apparatus.

FIG. 2C is a block diagram of a processing system.

FIG. 3 is a flowchart illustrating normal information calculation processing according to the first example.

FIG. 4 is a flowchart illustrating normal information calculation processing according to a second example.

FIG. 5 is an appearance view illustrating a normal information obtaining system according to a third example.

FIG. 6 is a chart explaining an obtaining method of polarization information.

FIG. 7 is a relationship diagram of a polarization azimuth and an incident surface.

FIG. 8 is a relationship diagram of an angle between a surface normal and a visual line direction vector of an image pickup apparatus.

FIG. 9A is a chart illustrating incident angle dependency of degree of polarization of a specular reflection component.

FIG. 9B is a chart illustrating emitting angle dependency of degree of polarization of a diffuse reflection component.

FIG. 10 is an explanatory diagram of a Torrance-Sparrow model.

FIG. 11 is a schematic diagram of an image pickup element where a pattern polarizer is disposed.

### DESCRIPTION OF THE PREFERRED EMBODIMENTS

Exemplary embodiments of the present invention will be described below with reference to the accompanied drawings. In each of the drawings, the same elements will be denoted by the same reference numerals and the duplicate descriptions thereof will be omitted.

In general, a polarization state of light is expressed by four parameters like Stokes parameters. In this embodiment, information regarding the polarization state of light is referred to as polarization information. The polarization information includes a quantity, such as degree of polarization, a polarization azimuth and a measurement error of the polarization state, secondarily obtained from the polarization information. To obtain the polarization information, four independent polarization components should be measured. However, in nature, a circular polarization component is rarely measured, and thus only linear polarization components are sufficient as polarization information of an object. That is, unpolarized light and circular polarization are obtained without distinction. In this case, intensities and luminance values of at least three different linear polarization components should be obtained. As light transmitting a polarizer is linear polarization polarized in a polarization principal axis direction, intensities and luminance values of light transmitting three or more polarizers different in principal axis angles should be measured.

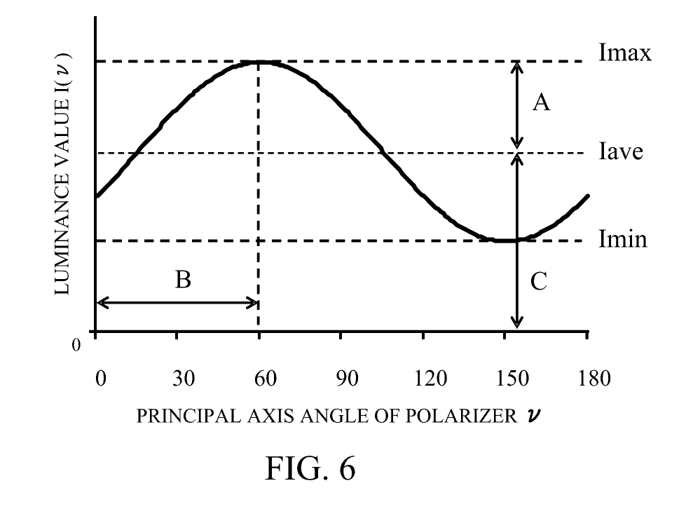

FIG. 6 is a chart explaining an obtaining method of the polarization information. In FIG. 6, an abscissa axis is a principal axis angle of a polarizer and an ordinate axis is a luminance value of light. When ν is the principal axis of the polarizer and I(ν) is the luminance value of light, the luminance value I(ν) is expressed by the following expression (1) using positive constants A, B and C of FIG. 6.

I(v)=A·cos 2(v−B)+C (1)

Calculating the constants A to C can obtain the polarization information. On the basis of periodicity of a cosine function, the constant B can be expressed as a value between 0 and 180 degrees.

As unknown constants are the three constants A to C, measuring the luminance values of light transmitting the three polarizer different in the principal axis angles can uniquely obtain the constants A to C. When the luminance values are measured on four or more polarization conditions, the constants A to C are obtained using fitting. In particular, the fitting may be performed by a known method such as a least-squares method using differences between measured values (νi, Ii) obtained from the i-th polarization condition and theoretical values expressed by the expression (1) as an evaluation function. Additionally, when the luminance value is measured using an image pickup apparatus, an output signal obtained through an image pickup system is preferably corrected so that the luminance value of actual light has a linear relation to the output signal.

Using the constants A to C calculated by the above method can obtain various polarization information. For example, the constant A is amplitude of the brightness value for the principal axis angle of the polarizer and the constant C is an average brightness value lave for the principal axis angle of the polarizer. Moreover, a maximum luminance value Imax, a minimum luminance value (an unpolarized component of the luminance value) Imin, a polarization azimuth (a phase angle of the polarizer where the luminance value is maximum) ψ, the degree of polarization ρ, and a polarization estimation error Ep are respectively expressed by the following expressions (2) to (6). Symbol Ii of the expression (6) represents a luminance value in the i-th polarization state.

Imax=A+C (2)

Imin=C−A (3)

ψ=B (4)

ρ=(Imax−Imin)/(Imax+Imin)=A/C (5)

$$Ep = {\sum }_{i} {( {I}_{i} - A \cdot cos 2 ( {v}_{i} - B ) - C )}^{2} \qquad ( 6 )$$

Next, a method obtaining a surface normal of the object from the polarization information will be explained. A unit surface normal vector of the object has two freedom degrees. From the above polarization information, conditional expressions satisfied by the unit surface normal vector satisfy can be obtained.

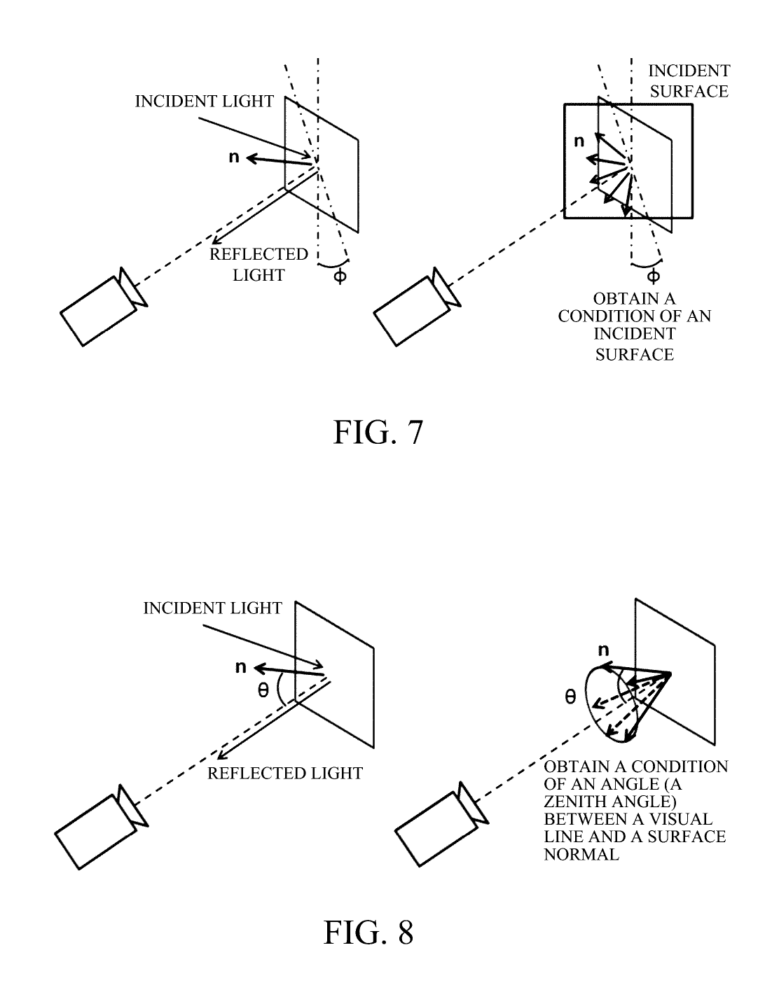

FIG. 7 is a relationship diagram of the polarization azimuth and an incident surface. As illustrated in FIG. 7, angle information of the incident surface or an emitting surface is obtained from the polarization azimuth. Main reason that reflected light from the object polarizes is a difference between each Fresnel reflectance for S polarization and P polarization. In a specular reflection, as the reflectance for the S polarization enlarges, the polarization azimuth is orthogonal to the incident surface. Furthermore, in the specular reflection, the incident surface is equal to the emitting surface. Meanwhile, in a diffuse reflection, when light diffused inside the object is emitted to the outside, transmittance for the P polarization enlarges and thus the polarization azimuth coincides with the emitting surface. Thus, in a surface orthogonal to a visual line direction vector of the image pickup apparatus, an azimuth angle φ of the surface normal is expressed by the following conditional expressions (7) and (8). However, the azimuth angle φ has indefiniteness of 180 degrees.

φ=ψ+π/2(specular reflection) (7)

φ=ψ(diffuse reflection) (8)

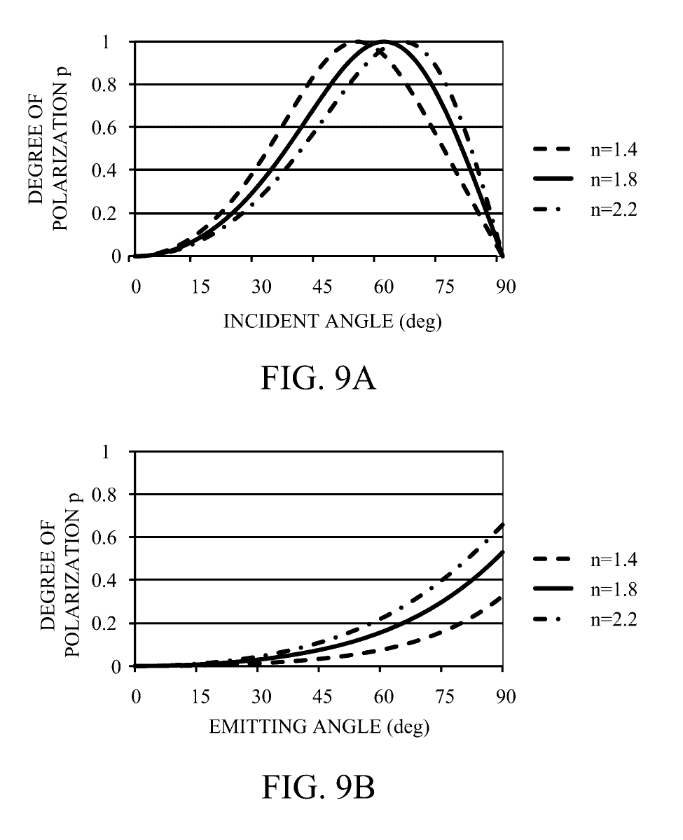

FIG. 8 is a relationship diagram of an angle between the surface normal and the visual line direction vector of the image pickup apparatus. FIG. 9A is a chart illustrating incident angle dependency of the degree of polarization of a specular reflection component, and FIG. 9B is a chart illustrating emitting angle dependency of the degree of polarization of a diffuse reflection component. In the specular reflection, an incident angle is equivalent to the angle between the surface normal of the object and the visual line direction vector of the image pickup apparatus, but two incident angles can be obtained with respect to one degree of polarization. In other words, candidates for a solution are limited to two. In the diffuse reflection, the degree of polarization and the emitting angle are in a one-to-one relation, and the angle between the surface normal of the object and the visual line direction vector of the image pickup apparatus is the emitting angle and is calculated from the degree of polarization.

Consequently, conditions that the surface normal satisfies can be obtained from the polarization information. Combining the plurality of conditions can estimate the surface normal. For example, combining polarization azimuth and degree of polarization from a single viewpoint can estimate the surface normal. In particular, when measured reflected light is the diffuse reflection component, the azimuth angle of the surface normal is determined from the polarization azimuth and one zenith angle is obtained from degree of polarization of the surface normal. At this time, the azimuth angle has indefiniteness of the angle of φ and φ+180 degrees, and thus two solutions of the surface normal are obtained.

When the measured reflected light is the specular reflection component, two zenith angles of the surface normal are obtained from the degree of polarization. In this case, candidates for the solution of the surface normal are limited to four with indefiniteness of the azimuth angle. When it is not specified that the measured reflected light is the diffuse reflection component, the specular reflection component, or their mixture component, a relation between the degree of polarization and the incident surface generates indefiniteness of angles of 90 degrees, and candidates for the solution of the surface normal further increases. Accordingly, the surface normal may be estimated using the known specular reflection and separation method (for example, “Constraining Object Features Using a Polarization Reflectance Model” (IEEE Trans. Patt. Anal. Mach. Intell., Vol. 13, No. 7, pp. 635-657(1991)) by L. B. Wolff, and “The Measurement of Highlights in Color Images” (IJCV, Vol. 2, No. 1, pp. 7-32(1988) by G. j. Klinker). This can decrease candidates for the solution of the surface normal and can obtain the surface normal accurately.

In this embodiment, to resolve indefiniteness of the solution in an estimation of the surface normal using the polarization information, luminance information at each light source position is used. Hereinafter, an illuminance difference stereo method to obtain the normal information of the object from variations of the luminance information at each light source position will be explained.

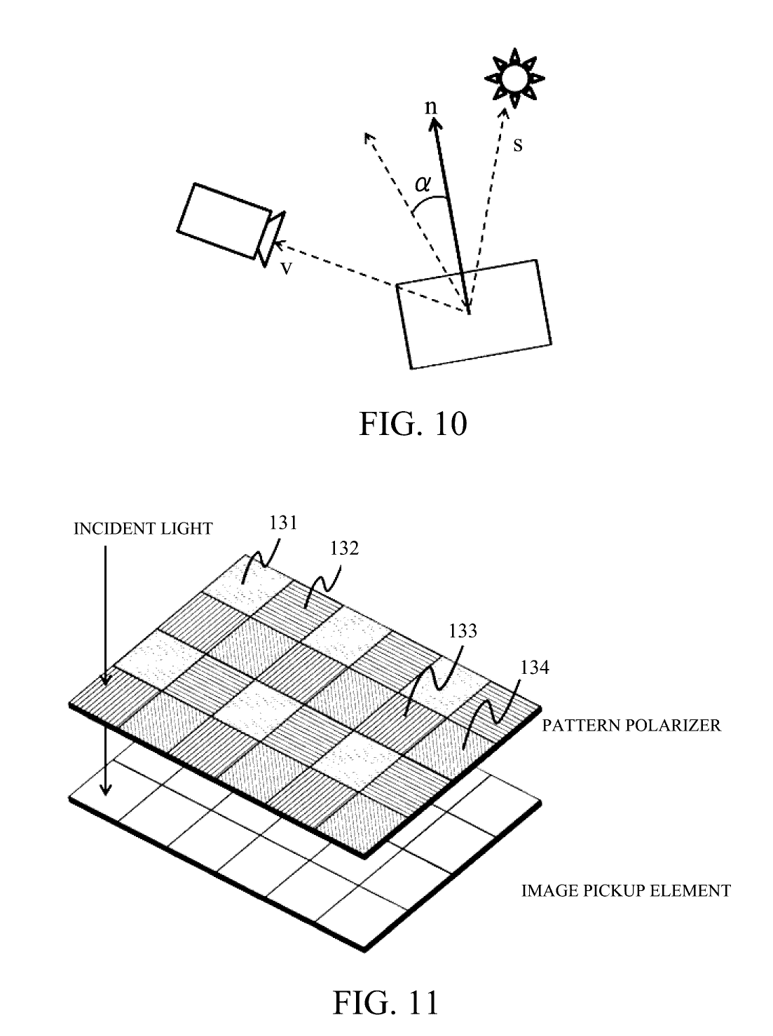

The illuminance difference stereo method is a method assuming reflectance characteristics of the object based on the surface normal of the object and a direction (a light source direction) from the object to the light source and calculating the surface normal from the reflectance characteristics assumed as the luminance information of the object at the plurality of light source positions. When the reflectance is not uniquely determined by receiving a predetermined surface normal and the light source position, the reflectance characteristics should be approximated using a Lambert reflection model in dependence upon a Lambert's cosine law. In addition, the specular reflection component, as illustrated in FIG. 10, depends on an angle α formed by a bisector of an angle between a light source vector s and the visual line direction vector v, and the surface normal n. Accordingly, the reflectance characteristics may be based on the visual line direction. Additionally, the luminance information may be excluded influence by light such as environmental light other than light from the light source by taking a difference between the luminance of the object imaged in the case where the light source is lighted and the luminance of the object imaged in the case where the light source is turned off.

Hereinafter, the reflectance characteristics assumed by the Lambert reflection model will be explained. When the luminance value of the reflected light is i, Lambert diffuse reflectance of the object is ρ_{d}, intensity of the incident light is E, a unit vector (a light source direction vector) representing a direction from the object to the light source is s, and the unit surface normal vector of the object is n, the luminance value i is expressed by the following expression (9) on the basis of the Lambert's cosine law.

i=Eρ_{d}s·n (9)

When components of different M (M≧3) light source vectors are respectively defined as s₁, s₂, . . . , s_{M} and luminance values for the components of the light source vectors are respectively defined as i₁, i₂, . . . , i_{M}, the expression (9) is expressed by the following expression (10).

$$[ \begin{matrix}{i}_{1} \\ ⋮ \\ {i}_{M}\end{matrix} ] = [ \begin{matrix}{s}_{1}^{T} \\ ⋮ \\ {s}_{M}^{T}\end{matrix} ] E {ρ}_{d} n \qquad ( 10 )$$

In the expression (10), the left side is luminance vectors expressed by a matrix of M row and 1 column, and a matrix [s₁^{T}, . . . s_{M}^{T}] and a symbol n of the right side are respectively incident light matrix S of M row and 3 column representing the light source direction and the unit surface normal vector expressed by a matrix of 3 row and 1 column. When the number M is equal to 3, a product Eρ_{d}n are expressed by the following expression (11) using an inverse matrix S⁻¹ of the incident light matrix S.

$$E {ρ}_{d} n = {S}^{- 1} [ \begin{matrix}{i}_{1} \\ ⋮ \\ {i}_{M}\end{matrix} ] \qquad ( 11 )$$

A norm of vectors of the left side of the expression (11) is a product of the intensity E of the incident light and the Lambert diffuse reflectance ρ_{d}, and a normalized vector is calculated as the surface normal of the object. In other words, the intensity E of the incident light and the Lambert diffuse reflectance ρ_{d} is expressed as the product in the expression. When the product Eρ_{d} is considered as one variable, the expression (11) is regarded as simultaneous equations to determine unknown three variables with two freedom degrees of the unit surface normal vector n. Thus, obtaining the luminance information using at least three light sources can determine each variable. When the incident light matrix S is not a regular matrix, an inverse matrix of the incident light matrix S does not exist and thus the components s₁ to s₃ of the incident light matrix S should be selected so that the incident light matrix S is the regular matrix. That is, the component s₃ is preferably selected linearly independently with respect to the components s₁ and s₂.

Additionally, when the number M is larger than 3, conditions more than unknown variables are obtained and thus the unit surface normal vector n may be calculated from arbitrary selected three conditional expressions using the same method as the method in the case where the number M is equal to 3. When four or more conditional expressions are used, the incident light matrix S is not the regular matrix. In this case, for example, an approximate solution should be calculated using a Moore-Penrose pseudo inverse matrix. The unit surface normal vector n may be also calculated using a fitting method and an optimization method.

When the reflectance characteristics are assumed by a model different from the Lambert reflection model, the conditional expression may differ from a linear equation for each component of the unit surface normal vector n. In this case, if the conditional expressions more than unknown variables are obtained, the fitting method and the optimization method can be used.

### First Example

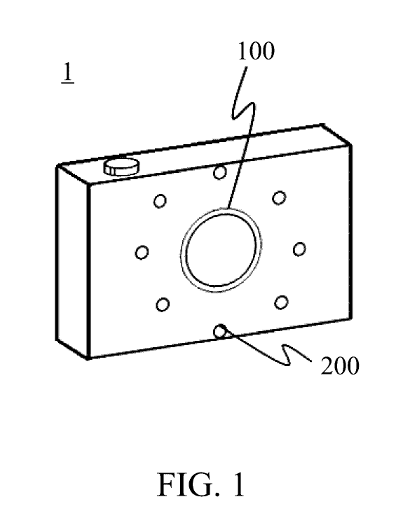

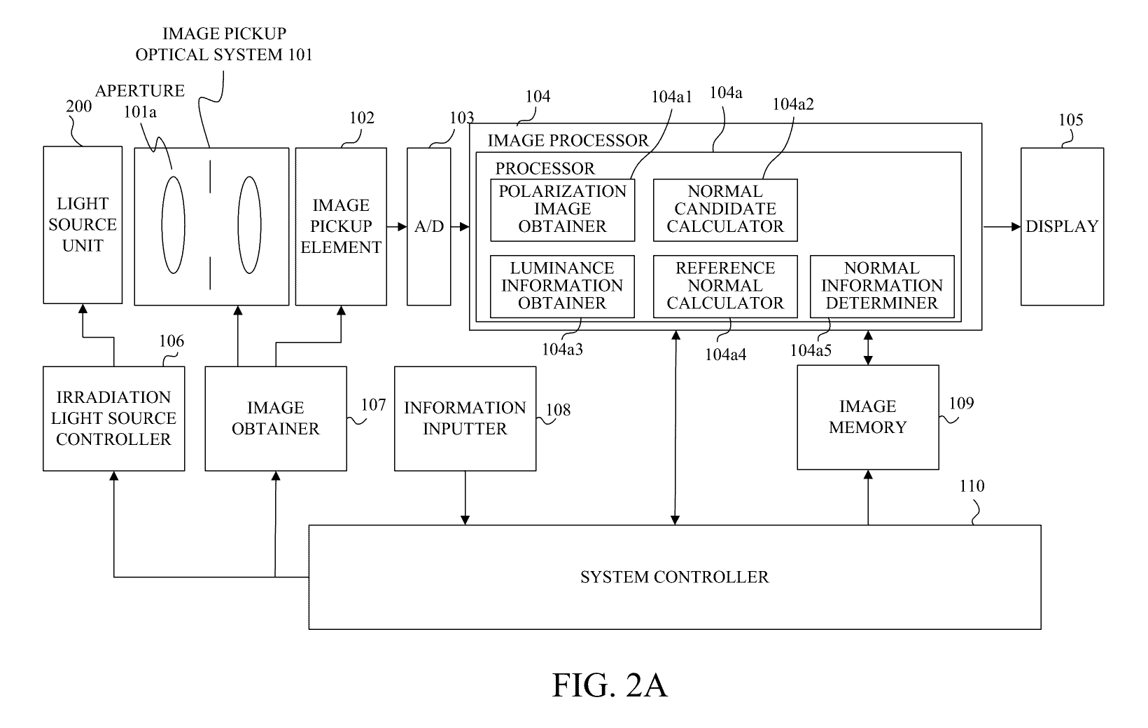

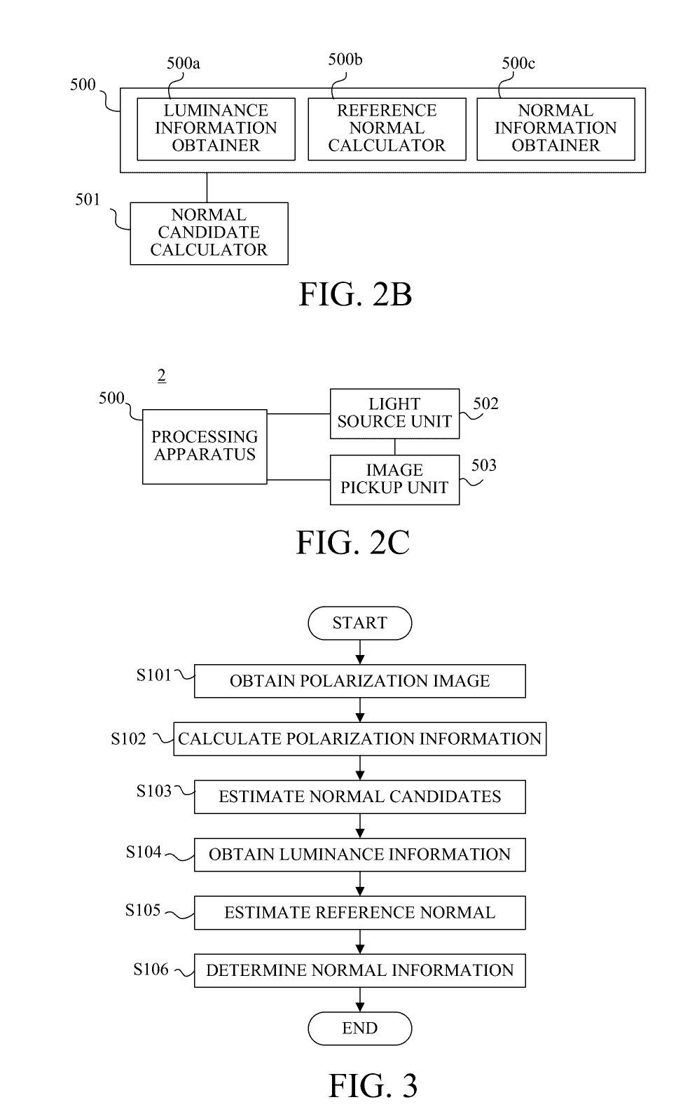

FIG. 1 is an appearance view of an image pickup apparatus 1 according to this example, and FIG. 2A is a block diagram of the image pickup apparatus 1. The image pickup apparatus 1 includes an image pickup unit 100 and a light source unit 200. The image pickup unit 100 includes an image pickup optical system 101. The light source unit 200 includes eight light sources arranged at equal intervals in a concentric circle shape around an optical axis of the image pickup optical system 101. As light sources necessary to perform the illuminance difference stereo method are three, the light source 200 may include three or more light sources. In this example, the light source unit 200 also includes a plurality of light sources arranged at equal intervals in the concentric circle shape around the optical axis of the image pickup optical system 101, but the present invention is not limited to this. In this example, the light source unit 200 is also built in the image pickup apparatus 1, but may be detachably attached to the image pickup apparatus 1.

The image pickup optical system 101 includes an aperture 101a and forms an image of light from an object on the image pickup element 102. The image pickup element 102 is configured by a photoelectric conversion element such as a CCD sensor and a CMOS sensor, and images the object. An analog electrical signal generated by a photoelectric conversion of the image pickup element 102 is converted into a digital signal by an A/D convertor 103 and the digital signal is input to an image processor 104.

The image processor 104 includes a part performing general image processing to the digital signal and a processor 104a calculating normal information of the object. In this example, the normal information includes not only a surface normal of the object but also information regarding a shape of the object such as shape data and a tilt of a surface. The processor 104 includes a polarization image obtainer 104a1, a normal candidate calculator 104a2, a luminance information obtainer 104a3, a reference normal calculator 104a4, and a normal information determiner 104a5. The polarization image obtainer 104a1 obtains polarization images. The normal candidate calculator 104a2 calculates normal candidates from the polarization images obtained by the polarization image obtainer 104a1. The luminance information obtainer 104a3 obtains luminance information at a plurality of light source positions. The reference normal calculator 104a4 calculates a reference normal from the luminance information obtained by the luminance information obtainer 104a3. The normal information determiner 104a5 determines normal information from the normal candidates. An output image processed by the image processor 104 is stored in an image memory 109 such as a semiconductor memory and an optical disc. The output image may be displayed by a display 105. The processor 104a may be configured separately from the image pickup apparatus 1 as described below.

An information inputter 108 supplies a system controller 110 with image pickup conditions (for example, an aperture value, an exposure time and a focal length) selected by a user. An image obtainer 107 obtains images on the desired condition selected by the user on the basis of information from the system controller 110. An irradiation light source controller 106 controls a light emitting state of the light source unit 200 depending on instructions from the system controller 110. The image pickup optical system 101 may be built in the image pickup apparatus 1 and may be detachably attached to the image pickup apparatus 1 as a single-lens reflex camera.

FIG. 3 is a flowchart illustrating normal information calculation processing according to this example. The normal information calculation processing according to this example is executed by the system controller 110 and the processer 104a in accordance with a processing program as a computer program. The processing program may be stored in, for example, a storage medium readable by a computer.

At step S101, the polarization image obtainer 104a1 obtains three or more polarization images with polarization state different in each other. The polarization image is an image obtained the luminance information having only a polarization component being part of reflected light from the object. The polarization image is obtained by inserting a polarizer before or after the image pickup optical system, or in the image pickup optical system, and imaging while varying a principal angle direction of the polarizer.

The polarization image may be also obtained by disposing a pattern polarizer before the image pickup element (for example, Japanese Patent Laid-Open 2007-86720). FIG. 11 is a schematic diagram of the image pickup element where the pattern polarizer is disposed. The pattern polarizer allows only a specific polarization component to enter a pixel of the image pickup element. In the pattern polarizer, a plurality of polarizer groups, for example, each of which is constituted of four polarizers 131 to 134 having transmission axes different by 45 degrees each as one set, are arranged. In the pattern polarizer, approximating that neighboring pixels observe the reflected light from the same point on the object can obtain polarization information similar to the polarization information obtained by imaging while varying the principal axis direction of a polarizer.

Moreover, the polarization image may be obtained in a state at least one light source is irradiated, or may be obtained for each of the plurality of light source positions.

At step S102, the normal candidate calculator 104a2 calculates polarization information from the polarization image obtained at step S101 using the previous described method. As an average luminance value of the polarization information is equal to a luminance value of the reflected light from the object, the average luminance value may be used as the luminance information obtained at step S104 as described below.

At step S103, the normal candidate calculator 104a2 calculates the plurality of normal candidates from the polarization information calculated at step S102 using the previous described method. By using the degree of polarization and the polarization azimuth, which are the polarization information, in the diffuse reflection, two normal candidates are calculated, and in the secular reflection, four normal candidates are calculated. The plurality of normal candidates may be calculated using either one of the degree of polarization and the polarization azimuth.

At step S104, the luminance information obtainer 104a3 obtains the luminance information for each of the plurality of light source positions from the plurality of images, each of which is obtained respectively by imaging the object at the plurality of light source positions. The plurality of shot images may be obtained by changing a position of a single light source or may be obtained using the plurality of light sources different in positions each. Moreover, the luminance information may be obtained using an image pickup optical system and an image pickup element different from the image pickup optical system and the image pickup element in obtaining the polarization image. When the polarization images are obtained for each of the plurality of the light source positions at step S101 and the average luminance value is calculated at step S102, the average luminance value may be obtained as the luminance information at step S104.

At step S105, the reference normal calculator 104a4 calculates a reference normal from the luminance information obtained at step S104. The reference normal is calculated on the basis of variations of the luminance information for each of the light source positions using the illuminance difference stereo method. In the illuminance difference stereo method, when the Lambert reflection model is not applied to the object, errors of the reference normal occurs, but does not matter to resolve indefiniteness of a solution as the plurality of normal candidates calculated from the polarization information.

At step S106, the normal information determiner 104a5 determines normal information from the plurality of normal candidates calculated at step S103 on the basis of the reference normal obtained at step S105. In particular, of the plurality of normal candidates, a normal candidate, which is the closest to the reference normal, is determined as the normal information.

When the normal candidates are calculated using the degree of polarization and the polarization azimuth, which are the polarization information, in a diffuse reflection part, two solutions exist as an azimuth angle of the normal information and thus a normal candidate having an azimuth angle closest to an azimuth angle of the reference normal is should be determined as the normal information. Furthermore, in a specular reflection part, as two solutions exist for each of both zenith and azimuth angles of the normal information, a normal candidate having zenith and azimuth angles respectively closest to zenith and azimuth angles of the reference normal should be determined as the normal information.

Additionally, when normal candidates are calculated using only the degree of polarization, in the diffuse reflection part, a plurality of solutions exist as the azimuth angle of the normal information and thus a normal candidate having an azimuth angle closest the azimuth angle of the reference normal should be determined as the normal information. Moreover, in the specular reflection part, as two solutions exist as the zenith angle of the normal information and a plurality of solutions exist as the azimuth angle of the normal information, a normal candidate having zenith and azimuth angles respectively closest to each of both zenith and azimuth angles of the reference normal should be determined as the normal information.

Further, when normal candidates are calculated using only the polarization azimuth, in the diffuse reflection part and the specular reflection part, a plurality of solutions and two solutions respectively exist as the zenith angle and the azimuth angle of the normal information. Thus, a normal candidate having zenith and azimuth angles respectively closest to each of both zenith and azimuth angles of the reference normal should be determined as the normal information.

In addition, when shade and the specular reflection are detected from at least one luminance information, the reference normal calculated from the shade region and the specular reflection part at step S105 may have a large error. Accordingly, in a part detecting the shade and the specular reflection, the normal information may be determined from the plurality of normal candidates using information with respect to the light source positions in obtaining the luminance information where the shade and the specular reflection are detected. For example, a normal of the shade region can be estimated to be faced to a position opposite to a position of the light source irradiating the object with light. Thus, a normal candidate farthest from a light source vector in obtaining the luminance information should be selected as the normal information. In a part generating shade at the plurality of light source positions, an average value of a normal candidate farthest from each light source vector may be determined as the normal information.

A normal of a region where specular reflection is caused can be estimated from a position of the light source irradiating the object with light and a camera direction. For example, a normal candidate closest to a half vector of the light source vector and a visual line vector (a vector connecting an aligned starting point of the light source vector and the visual line vector with an intermediate point of a line between ending points of the light source vector and the visual line vector) is determined as the normal information. Alternatively, a normal candidate within a constant range based on the half vector of the light source vector and the visual line vector (when the plurality of normal candidates exist, an average value of the normal candidates) can be determined as the normal information.

In this example, the normal information of the object is calculated in the image pickup apparatus 1, but, as illustrated in FIG. 2B, may be calculated using a processing apparatus 500 having a configuration different from that of the image pickup apparatus 1. The processing apparatus 500 includes a luminance information obtainer 500a, a reference normal calculator 500b and a normal information obtainer 500c. When the processing apparatus 500 calculates the surface normal, the luminance information obtainer 500a firstly obtains the luminance information for each of the plurality of light source positions from the plurality of images, each of which is obtained respectively by imaging the object at the plurality of light source positions. The reference normal calculator 500b secondly calculates the reference normal on the basis of the luminance information for each of the plurality of light source positions obtained by the luminance information obtainer 500a. The normal information obtainer 500c thirdly determines the normal information from the plurality of normal candidates calculated by a normal candidate calculator 501 on the basis of the reference normal obtained by the reference normal calculator 500b. The normal candidate calculator 501 may be configured separately from the processing apparatus 500, or may be built in the processing apparatus 500. Additionally, as describe in a second example, when the normal information is determined without calculating the reference normal, the processing apparatus 500 need not include the reference normal calculator 500b.

The processing apparatus 500 in FIG. 2B, as illustrated in FIG. 2C, is used as a processing system 2 with at least either one of a light source unit 502 illuminating an object and an image pickup unit 503 imaging the object. The light source unit 502 may include one light source movable to change its position, or may include at least three light sources different in positions each. When the light source unit 502 moves, the processing apparatus 500 may move the light source unit 502, or the image pickup unit 503 may move the light source unit 502.

As mentioned above, in this example, indefiniteness of a solution of the normal information calculated from the polarization information at a single viewpoint is resolved under a condition where information regarding an object shape is preliminarily unknown, and thereby the normal information of the object can be calculated.

### Second Example

In this example, a method determining normal information from a plurality of normal candidates using luminance information for each of a plurality of light source positions without calculating a reference normal will be explained. An image pickup apparatus according to this example is the same as the image pickup apparatus according to the first example, but the reference normal is not calculated in this example and thus the reference normal calculator 104a4 is not required.

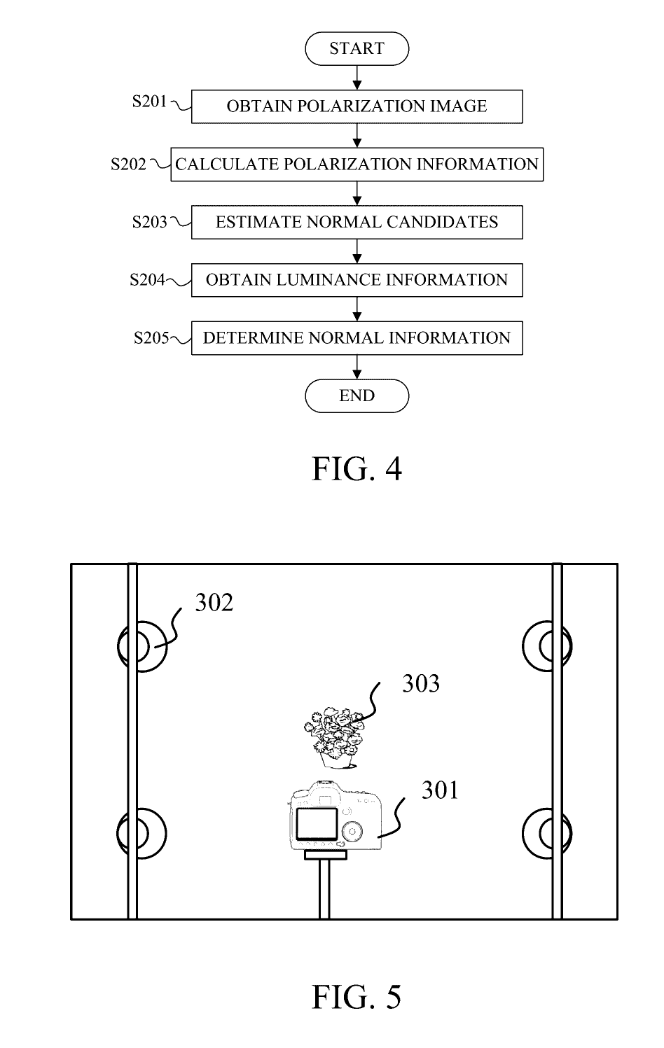

FIG. 4 is a flowchart illustrating normal information calculation processing according to this example. The normal information calculation processing according to this example is executed by the system controller 110 and the image processor 104 in accordance with a processing program as a computer program. The processing program may be stored in, for example, a storage medium readable by a computer.

As steps S201 to S204 are respectively the same as steps S101 to S104 of FIG. 3, detail explanations thereof are omitted.

At step S205, the normal information is determined from the plurality of normal candidates obtained at step S203 on the basis of the luminance information for each of the plurality of light source positions obtained at step S204. In the diffuse reflection model represented by the Lambert reflection model, luminance of the reflected light increase with an approach of a direction of the normal vector and the light source direction. Thus, a normal candidate closest to the light source vector having the highest luminance of the luminance information for each of the plurality of light source positions should be determined as the normal information. Furthermore, as the first example, when the shade and the specular reflection are detected, the normal information may be determined from the plurality of normal candidates using the information with respect to the light source position.

As mentioned above, in this example, indefiniteness of a solution of the normal information calculated from the polarization information at a single viewpoint is resolved under a condition where information regarding an object shape is preliminarily unknown, and thereby the normal information of the object can be calculated.

### Third Example

In the first and second examples, the image pickup apparatus including the light source was explained, but, in this example, a normal information obtaining system including an image pickup apparatus and a light source unit will be explained.

FIG. 5 is an appearance view illustrating a normal information obtaining system. The normal information obtaining system includes an image pickup apparatus 301 imaging an object 303, and a plurality of light source unit 302. The image pickup apparatus 301 according to this example is the same as that according to the first embodiment, but need not include the plurality of light sources.

The light source unit 302 is connected with the image pickup apparatus 301 by wire or wireless and is preferably controlled on the basis of information from the image pickup apparatus 301. Additionally, in the illuminance difference stereo method, at least three light sources are required, but a light source unit may include at least one light source if can change the light source position. However, changing the light source position at least three times is required to image for each of at least three light source positions. When the light source unit 302 cannot automatically change the light source positions or cannot be controlled by the image pickup apparatus 301, users may adjust the light source unit 302 to move the light source position displayed by a display of the image pickup apparatus 301.

As mentioned above, in this example, indefiniteness of a solution of the normal information calculated from the polarization information at a single viewpoint is resolved under a condition where information regarding an object shape is preliminarily unknown, and thereby the normal information of the object can be calculated. As normal information calculation processing according to this example is the same as the processing of the first or second example, detailed explanations thereof are omitted.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2015-200032, filed on Oct. 8, 2015, which is hereby incorporated by reference herein in its entirety.

What is claimed is:

1. A processing apparatus comprising:
a luminance information obtainer that obtains luminance information for each of a plurality of images, each of the images being shot respectively when a light source arranged at mutually different positions illuminates an object; and
a normal information determiner that determines normal information of the object from a plurality of normal candidates calculated using three or more polarization images with polarization states different in each other on the basis of the luminance information.

2. The processing apparatus according to claim 1, further comprising a normal candidate calculator that calculates the plurality of normal candidates using the three or more polarization images.

3. The processing apparatus according to claim 1, further comprising a reference normal calculator that calculates a reference normal of the object using the luminance information,
wherein the normal information determiner determines the normal information of the object from the plurality of normal candidates on the basis of the reference normal of the object.

4. The processing apparatus according to claim 3, wherein the normal information determiner determines a normal candidate closest to the reference normal from the plurality of normal candidates as the normal information of the object.

5. The processing apparatus according to claim 3, wherein the normal information determiner determines the normal information of the object from the plurality of normal candidates on the basis of at least either one of an azimuth angle and a zenith angle of the reference normal of the object.

6. The processing apparatus according to claim 1, wherein the normal information determiner determines the normal information of the object from the plurality of normal candidates on the basis of a light source direction where a luminance value of the luminance information is the highest.

7. The processing apparatus according to claim 1, wherein, when a shade region having a luminance value lower than a predetermined luminance value is detected from the luminance information, the normal information determiner determines the normal information of the object from the plurality of normal candidates on the basis of a light source direction of a light source used in obtaining luminance information where the shade region is detected.

8. The processing apparatus according to claim 1, wherein, when a region reflecting specularly is detected from the luminance information, the normal information determiner determines the normal information of the object from the plurality of normal candidates on the basis of a light source direction of a light source used in obtaining luminance information where the region is detected.

9. A processing system comprising:
at least one light source that illuminates an object; and
a processing apparatus,
wherein the processing apparatus includes:
a luminance information obtainer that obtains luminance information for each of a plurality of images, each of the images being shot respectively when the light source arranged at mutually different positions illuminates the object; and
a normal information determiner that determines normal information of the object from a plurality of normal candidates calculated using three or more polarization images with polarization states different in each other on the basis of the luminance information.

10. The processing system according to claim 9, wherein the at least one light source is movable.

11. The processing system according to claim 9, wherein the least one light source includes three or more light sources mutually different in positions.

12. The processing system according to claim 9, further comprising an image pickup unit imaging the object.

13. An image pickup apparatus comprising:
a processing apparatus; and
an image pickup element that images an object,
wherein the processing apparatus includes:
a luminance information obtainer that obtains luminance information for each of a plurality of images, each of the images being shot respectively when the light source arranged at mutually different positions illuminates the object; and
a normal information determiner that determines normal information of the object from a plurality of normal candidates calculated using three or more polarization images with polarization states different in each other on the basis of the luminance information.

14. A processing method comprising:
a step of obtaining luminance information for each of a plurality of images, each of the images being shot respectively when the light source arranged at mutually different positions illuminates the object; and
a step of determining normal information of the object from a plurality of normal candidates calculated using three or more polarization images with polarization states different in each other on the basis of the luminance information.

15. A non-transitory computer-readable storage medium configured to store a computer program that enables a computer to execute a processing method,
wherein the processing method includes:
a step of obtaining luminance information for each of a plurality of images, each of the images being shot respectively when the light source arranged at mutually different positions illuminates the object; and
a step of determining normal information of the object from a plurality of normal candidates calculated using three or more polarization images with polarization states different in each other on the basis of the luminance information.
